(19) United States
(12) Patent Application Publication
(10) Pub. No.: US 2021/0163273 A1
(43) Pub. Date: Jun. 3, 2021

(54) TRANSPORT DEVICE AND ROBOT INCLUDING SAME

(71) Applicant: LG ELECTRONICS INC., Seoul (KR)

(72) Inventors: Zhimin CHOO, Seoul (KR); Sungil CHO, Seoul (KR)

(21) Appl. No.: 16/849,165

(22) Filed: Apr. 15, 2020

(30) Foreign Application Priority Data
Dec. 3, 2019 (KR) 10-2019-0159209

(51) Int. Cl. B66F 9/06; B65G 59/06; B25J 15/00; B25J 9/16

(52) U.S. Cl. CPC B66F 9/063; B65G 59/061; G06N 3/04; B25J 9/161; B25J 9/163; B25J 15/0014

(57) ABSTRACT

A transport device includes: a device frame; a first stage unit placed in the device frame to be movable in a vertical direction; a second stage unit placed in the first stage unit to be movable in a vertical direction; and a pusher unit placed in the first stage unit, and provided to discharge a transport object outward, wherein the transport object includes a first transport object and a second transport object stacked on the first transport object, and wherein while the pusher unit discharges the first transport object, the second stage unit supports the second transport object, and after the pusher unit discharges the first transport object, the second stage unit causes the second transport object to be mounted on the pusher unit.

### CROSS-REFERENCE TO RELATED APPLICATION

This application claims priority under 35 U.S.C. §119 to Korean Application No. 10-2019-0159209 filed on Dec. 3, 2019, whose entire disclosure is hereby incorporated by reference.

### BACKGROUND

### 1. Field

The present disclosure relates to a transport device, and a robot including the transport device. More particularly, the present disclosure relates to a transport device and a robot including the same, the transport device being capable of automatically off-loading transport objects which are staked in multiple layers, starting from the object on the lower layer to the object on the upper layer sequentially.

### 2. Background

In general, a transport device is a general name for a device that transfers an object to be transported (hereinafter, referred to as a transport object) to a location which a user targets. In the past, the transport device off-loaded a transport object with the user working manually or using a machine, such as a crane, or the like. Accordingly, the user's work fatigue is large. Further, when the weight of the transport object is heavy, a separate machine is required.

Recently, as technological advances, such as artificial intelligence, autonomous driving, robots, and the like, have been achieved, unlike the past, a technique has been developed in which a transport device autonomously transfers a transport object to a target location and the transport object is automatically off-loaded through various sensing operations, robot operations, and the like.

### BRIEF DESCRIPTION OF THE DRAWINGS

The embodiments will be described in detail with reference to the following drawings in which like reference numerals refer to like elements wherein:

FIG. 1 is a view showing an AI apparatus according to an embodiment of the present disclosure;

FIG. 2 is a view showing an AI server according to an embodiment of the present disclosure;

FIG. 3 is a view showing an AI system according to an embodiment of the present disclosure;

FIG. 4 is a view showing a robot according to an embodiment of the present disclosure;

FIG. 5 is a front view showing a transport device according to embodiments of the present disclosure;

FIG. 6 is a side view showing a transport device according to embodiments of the present disclosure;

FIG. 7 is a bottom view showing a transport device according to embodiments of the present disclosure;

FIG. 8 is a plan view showing a transport device according to embodiments of the present disclosure;

FIG. 9 is a back view showing a transport device according to embodiments of the present disclosure;

FIG. 10 is a perspective view showing a transport device according to embodiments of the present disclosure;

FIG. 11 is an exploded perspective view showing a transport device according to embodiments of the present disclosure;

FIG. 12 is an exploded side view showing a transport device according to embodiments of the present disclosure;

FIG. 13 is an exploded perspective view showing a pusher unit according to embodiments of the present disclosure;

FIG. 14 is a perspective view showing a second stage unit according to embodiments of the present disclosure;

FIG. 15 is a view showing a state in which multiple transport objects are stacked in a transport device according to embodiments of the present disclosure; and

FIGS. 16A to 16H are views showing a state in which multiple transport objects are off-loaded by a transport device according to embodiments of the present disclosure.

### DETAILED DESCRIPTION

Artificial intelligence refers to the field of researching artificial intelligence or the methodology to create the same, and machine learning refers to the field of defining various problems in the field of artificial intelligence and researching the methodology for solving the problems. Machine learning is defined as an algorithm that improves the performance of an operation by performing a consistent experience for the operation.

An artificial neural network (ANN) is a model used in machine learning, configured with artificial neurons (nodes) constituting a network in a synapse coupling, and means a model with problem solving ability. The artificial neural network may be defined by a connection pattern between neurons of other layers, a learning process of updating a model parameter, and an activation function generating an output value.

The artificial neural network may include an input layer, an output layer, and at least one selective hidden layer. Each layer may include at least one neuron, and the artificial neural network may include a synapse that connects neurons. In the artificial neural network, each neuron may output input signals input through a synapse, weights, and a function value of an activation function for a bias.

The model parameter means a parameter determined through learning, and includes a weight of a synapse connection, a bias of a neuron, etc. In addition, a hyper-parameter means a parameter that has to be set before performing learning in a machine learning algorithm, and includes a learning rate, a number of repetition times, a size of a mini-batch, an initialization function, etc.

An objective of performing learning for an artificial neural network is to determine a model parameter that minimizes a loss function. The loss function may be used as an index for determining an optimum model parameter in a learning process of the artificial neural network.

Machine learning may be classified into supervised learning, unsupervised learning, and reinforcement learning according to a learning method. Supervised learning may mean a method of performing learning for an artificial neural network where a label related to learning data is provided, and the label may mean a right answer (or result value) that has to be estimated by the artificial neural network when the learning data is input to the artificial neural network. Unsupervised learning may mean a method of performing learning for an artificial neural network where a label related to learning data is not provided. Reinforcement learning may mean a learning method performing learning so as to select, by an agent defined under a certain environment, an action or an order thereof such that an accumulated reward in each state is maximized.

Machine learning, among artificial neural networks, employed in a deep neural network (DNN) including a plurality of hidden layers, is referred to as deep learning, and the deep learning is a part of the machine learning. Hereinafter, machine learning is used to include deep learning.

A robot may mean a machine capable of automatically carrying out or operating a given operation by its own ability. Particularly, a robot having a function of recognizing an environment, and performing an operation by performing determination by itself may be referred to as an intelligent robot.

A robot may be classified into an industrial type, a medical type, a household type, a military type, etc. according to the usage purpose or field. The robot may be provided with a manipulator including an actuator or a driving device so that the robot may perform various physical operations such as moving a robot joint, and so on. In addition, a movable robot may navigate on the ground or fly in the air by including wheels, brakes and propellers, etc.

Self-driving means the technology of autonomous driving, and a self-driving vehicle means a vehicle that drives without user's manipulations or with the minimum manipulation of the user. For example, self-driving may include the technique of maintaining a driving lane, the technique of automatically adjusting a speed such as adaptive cruise control, the technique of automatically driving along a predetermined route, the technique of automatically setting a route when a destination is set, etc.

Vehicles may include a vehicle with only an internal combustion engine, a hybrid vehicle with an internal combustion engine and an electric motor together, and an electric vehicle with only an electric motor, and may include not only automobiles but also trains and motorcycles. Herein, a self-driving vehicle may be referred to as a robot with a self-driving function.

Extended reality refers to virtual reality (VR), augmented reality (AR), and mixed reality (MR). The VR technique provides objects and backgrounds of the real world in CG images, the AR technique provides virtual CG images by reflecting the same on real object images, and the MR technique is a computer graphic technique mixing and coupling virtual objects and providing by reflecting the same in the real word.

The MR technique is similar to the AR technique in that real objects and virtual objects are provided together. In the AR technique, virtual objects are used to complement real objects, but in the MR technique, virtual objects and real objects are equivalently used.

The XR technique may be applied by using a head-mount display (HMD), a head-up display (HUD), a mobile phone, a tablet PC, a laptop PC, a desktop PC, a TV, a digital signage, etc., and a device to which the XR technique is applied may be referred to an XR device.

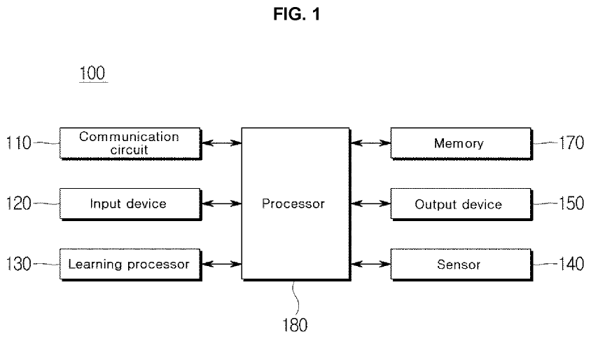

FIG. 1 is a view showing an AI apparatus 100 according to an embodiment of the present disclosure. The AI apparatus 100 may be employed in a fixed or movable type device such as TVs, projectors, mobile phones, smart phones, desktop PCs, laptop PCs, digital broadcasting terminals, PDAs (personal digital assistants), PMPs (portable multimedia player), navigations, tablet PCs, wearable devices, set-top boxes (STB), DMB receiver, radios, washers, refrigerators, digital signages, robots, vehicles, etc. Referring to FIG. 1, the AI apparatus 100 may include a communication circuit 110, an input device 120, a learning processor 130, a sensor 140, an output device 150, a memory 170, and a processor 180.

The communication circuit 110 may transmit and receive data to/from another AI apparatuses (100a to 100e) or external devices such as an AI server 200 by using wired/wireless communication methods. For example, the communication circuit 110 may transmit and receive sensor information, user input, learning model, control signals, etc. to/from external devices. Herein, communication methods used by the communication circuit 110 include global system for mobile communication (GSM)), code division multi access (CDMA), long term evolution (LTE), 5G, wireless LAN (WLAN), wireless-fidelity (Wi-Fi), Bluetooth™, radio frequency identification (RFID), infrared data association (IrDA), ZigBee, near field communication (NFC), etc.

The input device 120 may be for obtaining various types of data. Herein, the input device 120 may include a camera for an image signal input, a microphone for receiving audio signals, and a user input part for receiving information from the user. Herein, signals obtained from the camera or microphone by using the same as sensors may be referred to as sensing data or sensor information.

The input device 120 may be for obtaining input data used for outputting that is performed by using learning data and a learning model for model learning. The input device 120 may be for obtaining input data that is not processed. Herein, the processor 180 or learning processor 130 may obtain an input feature from input data as preprocessing.

The learning processor 130 may perform learning for a model configured with an artificial neural network by using learning data. Herein, the artificial neural network for which learning is performed may be referred to as a learning model. The learning model may be used for estimating a result value for new input data other than learning data, and the estimated value may be used as a reference for performing a certain operation.

Herein, the learning processor 130 may perform AI processing with a learning processor 240 of the AI server 200. Herein, the learning processor 130 may be integrated in the AI apparatus 100 or may include a memory employed therein. Alternatively, the learning processor 130 may be employed by using the memory 170, an external memory directly connected to the AI apparatus 100, or a memory maintained in an external device.

The sensor 140 may obtain at least one among internal information of the AI apparatus 100, surrounding environmental information of the AI apparatus 100, and user information by using various sensors. Herein, the sensor 140 may include a proximity sensor, an ambient light sensor, an acceleration sensor, a magnetic sensor, a gyro sensor, an inertial sensor, an RGB sensor, an IR sensor, a fingerprint recognizing sensor, a ultrasonic sensor, an optical sensor, a microphone, a lidar, a radar, etc.

The output device 150 may generate an output related to visual, auditory, or tactile. Herein, the output device 150 may include a display for visually outputting information, a speaker for acoustically outputting information, and a haptic actuator for tactually outputting information. For example, the display may output an image or video, the speaker may output a voice or sound, and the haptic actuator may output vibration.

The memory 170 may be for storing data supporting various functions of the AI apparatus 100. For example, in the memory 170, input data obtained through the input device 120, learning data, a learning model, a learning history, etc. may be stored.

The processor 180 may determine at least one executable operation of the AI apparatus 100 which is determined on the basis of information determined or generated by using a data analysis algorithm or machine learning algorithm. In addition, the processor 180 may perform the determined operation by controlling components of the AI apparatus 100.

For the same, the processor 180 may make a request, retrieve, receive, or use data of the learning processor 130 or the memory 170, and control components of the AI apparatus 100 so as to perform the estimated operation of the at least one executable operation, or an operation that is determined to be desirable. Herein, in order to perform the determined operation, the processor 180 may generate, when association with an external device is required, a control signal for controlling the corresponding external device, and transmit the generated control signal to the corresponding external device.

The processor 180 may obtain intention information on the user's input, and determine a user's requirement on the basis of the obtained intention information. Herein, the processor 180 may obtain intention information in association with the user's input by using at least one among a STT (speech-to-text) engine converting a voice input into text strings, and a natural language processing (NLP) engine obtaining intention information of natural language.

Herein, a part of the at least one among the STT engine and the NLP engine may be configured with an artificial neural network for which learning is performed according to a machine learning algorithm. In addition, for at least one among the STT engine and the NLP engine, learning may be performed by the learning processor 130, learning may be is performed by the learning processor 240 of the AI server 200, or learning may be performed through distribution processing of the above processors.

The processor 180 may collect record information including operation content of the AI apparatus 100 and user's feedback in association with the operation, etc. so as to store in the memory 170 or learning processor 130, or transmit the information to the external device such as an AI server 200, etc. The collected record information may be used when updating a learning model.

The processor 180 may control a part of components of the AI apparatus 100 so as to execute application programs stored in the memory 170. Further, the processor 180 may operate components of the AI apparatus 100 by combining at least two thereof so as to execute the application programs.

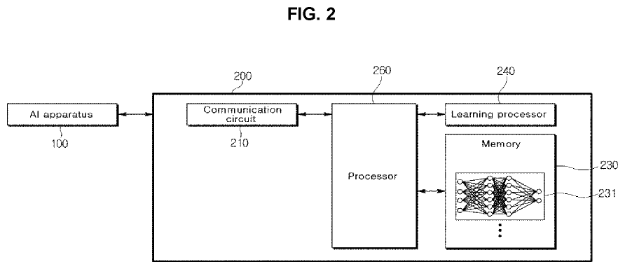

FIG. 2 is a view showing an AI server 200 according to an embodiment of the present disclosure. Referring to FIG. 2, an AI server 200 may mean a device performing learning for an artificial neural network by using a machine learning algorithm, or a device using the artificial neural network for which learning is performed. Herein, the AI server 200 may perform distributed processing by being configured with a plurality of servers, or may be defined as a 5G network. Herein, the AI server 200 may perform at least a part of AI processing by being included as a partial component of the AI apparatus 100.

Herein, the AI server 200 may perform at least a part of AI processing by being included as a partial component of the AI apparatus 100. The communication circuit 210 may transmit and receive data to/from the external devices such as AI apparatus 100, etc.

The memory 230 may be for storing a model (or artificial neural network, 231) for which learning is ongoing or performed by the learning processor 240. The learning processor 240 may perform learning for an artificial neural network 231 by using learning data. A learning model may be used by being integrated in the AI server 200 of the artificial neural network, or by being integrated in the external device such as an AI apparatus 100, etc.

The learning model may be employed in hardware, software, or combination thereof. When a part or the entire of the learning model is employed in software, at least one instruction constituting the learning model may be stored in the memory 230. The processor 260 may estimate a result value for new input data by using the learning model, and generate a response or control command on the basis of the estimated result value.

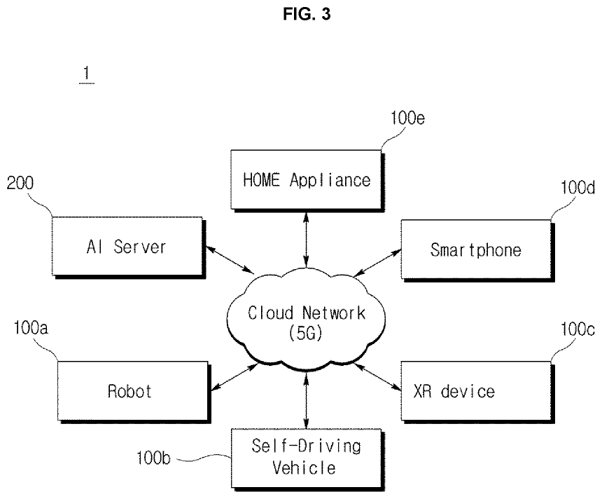

FIG. 3 is a view showing an AI system 1 according to an embodiment of the present disclosure. Referring to FIG. 3, the AI system 1 is connected to at least one cloud network 10 among the AI server 200, a robot 100a, self-driving vehicle 100b, an XR device 100c, a smart phone 100d, and a home appliance 100e. Herein, the robot 100a, the self-driving vehicle 100b, the XR device 100c, the smart phone 100d or the home appliance 100e to which the AI technique is applied may be referred to as the AI apparatus (100a to 100e).

The cloud network 10 may mean a network constituting a part of cloud computing infrastructure or a network present in the cloud computing infrastructure. Herein, the cloud network 10 may be configured by using a 3G network, a 4G or LTE network, a 5G network, etc. In other words, each device (100a to 100e, 200) constituting the AI system 1 may be connected with each other through the cloud network 10. Particularly, each device (100a to 100e, 200) may perform communication with each other through a base station, and also may perform direct communication without using the base station.

The AI server 200 may include a server performing AI processing, and a server performing calculation for big data. The AI server 200 may be connected to at least one of AI apparatus constituting an AI system 1 configured with the robot 100a, the self-driving vehicle 100b, the XR device 100c, the smart phone 100d, and the home appliance 100e through the cloud network 10, and the AI server 200 may support a part of the AI processing of the connected AI apparatuses (100a to 100e).

Herein, the AI server 200 may perform learning on an artificial neural network according to a machine learning algorithm in place of the AI apparatus (100a to 100e), may directly store a learning model, or transmit the learning model to the AI apparatus (100a to 100e). Herein, the AI server 200 may receive input data from the AI apparatus (100a to 100e), estimate a result value for the received input data by using a learning model, and generate a response or control command on the basis of the estimated result value so as to transmit the same to the AI apparatus (100a to 100e). Alternatively, the AI apparatus (100a to 100e) may estimate a result value for the received input data by directly using a learning model, and generate a response or control command on the basis of the estimated result value.

Hereinafter, various examples of the AI apparatus (100a to 100e) to which the above described technique is applied will be described. Herein, the AI apparatus (100a to 100e) shown in FIG. 3 may be referred to a detailed example of the AI apparatus 100 shown in FIG. 1.

The robot 100a may be employed in a guide robot, a transport robot, a cleaning robot, a wearable robot, an entertainment robot, a pet robot, an unmanned flying robot, etc. by applying the AI technique thereto. The robot 100a may include a robot control module for controlling operations, and the robot control module may mean a software module or a chip where the same is employed therein.

The robot 100a may obtain state information of the robot 100a, detect (recognize) a surrounding environment or objects, generate map data, determine a moving path or driving plan, determine a response in association with a user interaction, or determine operations by using sensor information that is obtained through various types of sensors. Herein, in order to determine a moving path or driving plan, the robot 100a may use sensor information obtained by using at least one sensor of a lidar, a radar, and a camera.

The robot 100a may perform the above operations by using a learning model configured with at least one artificial neural network. For example, the robot 100a may recognize a surrounding environment and objects by using a learning model, and determine operations by using the recognized surrounding environment information or object information. Herein, the learning model may be obtained by directly performing learning by the robot 100a, or by performing learning by the external device such as an AI server 200, etc.

Herein, the robot 100a may generate a result by directly using the learning model so as to perform operations. However, the robot 100a may transmit the sensor information to the external device such as an AI server 200, and receive a result generated according thereto so as to perform operations.

The robot 100a may determine a moving path and a driving plan by using at least one among map data, object information detected from the sensor information, and object information obtained from the external device, and drive according to the determined moving path and the driving plan by controlling a driving part.

Map data may include object identification information on various objects arranged in a space where the robot 100a moves. For example, the map data may include object identification information on fixed objects such as walls, doors, etc., and movable objects such as flowerpots, tables, etc. In addition, the object identification information may include a name, a type, a distance, a position, etc.

In addition, the robot 100a may perform operations or drive by controlling the driving part on the basis of the user's control/interaction. Herein, the robot 100a may obtain intention information on interaction according to a user's behavior or voice input, and determine a response on the basis of the obtained intention information so as to perform operations.

The self-driving vehicle 100b may be employed as a movable robot, a vehicle, an unmanned flying robot, etc. by applying the AI technique thereto. The self-driving vehicle 100b may include a self-driving control module controlling a self-driving function, and the self-driving control module may mean a software module or a chip where the same is employed in hardware. The self-driving control module may be included in the self-driving vehicle 100b as a component thereof, but may be connected to the self-driving vehicle 100b by being configured in separate hardware.

The self-driving vehicle 100b may obtain state information of the self-driving vehicle 100b, detect (recognize) a surrounding environment and objects, generate map data, determine a moving path and a driving plan, or determine operations by using sensor information obtained through various types of sensors.

Herein, in order to determine a moving path or driving plan, the self-driving vehicle 100b, similar to the robot 100a, may use sensor information obtained by using at least one sensor of a lidar, a radar, and a camera. Particularly, the self-driving vehicle 100b may recognize an environment and objects for areas that are hidden from view or over a certain distance by receiving sensor information from external devices, or by receiving information directly recognized from the external devices.

The self-driving vehicle 100b may perform the above operations by using a learning model configured with at least one artificial neural network. For example, the self-driving vehicle 100b may recognize a surrounding environment and objects by using a learning model, and determine a driving path by using the recognized surrounding environment information or object information. Herein, the learning model may be obtained by directly performing learning by the self-driving vehicle 100b, or by performing learning by the external device such as an AI server 200, etc.

Herein, the self-driving vehicle 100b may generate a result by directly using the learning model so as to perform operations. However, the self-driving vehicle 100b may transmit the sensor information to the external device such as an AI server 200, and receive a result generated according thereto so as to perform operations.

The self-driving vehicle 100b may determine a moving path and a driving plan by using at least one among map data, object information detected from the sensor information, and object information obtained from the external device, and drive according to the determined moving path and the driving plan by controlling a driving part.

Map data may include object identification information on various objects (for example, roads) arranged in a space where the self-driving vehicle 100b drives. For example, the map data may include object identification information on fixed objects such as street lamps, rocks, buildings, etc. and movable objects such as vehicles, pedestrians, etc. In addition, the object identification information may include a name, a type, a distance, a position, etc.

In addition, the self-driving vehicle 100b may perform operations or drive by controlling the driving part on the basis of the user's control/interaction. Herein, the self-driving vehicle 100b may obtain intention information on interaction according to a user's behavior or voice input, and determine a response on the basis of the obtained intention information so as to perform operations.

The XR device 100c may be employed by using a HMD, a HUD provided in a vehicle, a TV, a mobile phone, a smart phone, a PC, a wearable device, a home appliance, a digital signage, a vehicle, or a fixed type robot or movable type robot. The XR device 100c analyze 3D point cloud data or image data which is obtained through various sensors or external devices, generate position data and feature data on 3D points, and obtain information on a surrounding space and real objects and output XR objects to be rendered. For example, the XR device 100c may output XR objects including additional information on the recognized objects by reflecting the same in the corresponding recognized objects.

The XR device 100c may perform the above operations by using a learning model configured with at least one artificial neural network. For example, the XR device 100c may recognize real objects from 3D point cloud data or image data by using a learning model, and provide information in association with the recognized real objects. Herein, the learning model may be obtained by directly performing learning by the XR device 100c, or by performing learning by the external device such as an AI server 200, etc.

Herein, the XR device 100c may generate a result by directly using the learning model so as to perform operations. However, the XR device 100c may transmit the sensor information to the external device such as an AI server 200, and receive a result generated according thereto so as to perform operations.

The robot 100a may be employed in a guide robot, a transport robot, a cleaning robot, a wearable robot, an entertainment robot, a pet robot, an unmanned flying robot, etc. by applying the AI technique and the self-driving technique thereto. The robot 100a to which the AI technique and the self-driving technique are applied may mean a robot itself with a self-driving function, or the robot 100a operating in conjunction with the self-driving vehicle 100b.

The robot 100a with the self-driving function may refer to all devices moving by itself according to a given movement, or by determining a moving path by itself without a user control. The robot 100a and the self-driving vehicle 100b which respectively have self-driving functions may use a common sensing method for determining at least one among a moving path and a driving plan. For example, the robot 100a and the self-driving vehicle 100b which respectively have self-driving functions may determine a moving path or driving plan by using information sensed through a lidar, a radar, a camera, etc. The robot 100a operating in conjunction with the self-driving vehicle 100b may be present separate from the self-driving vehicle 100b, while the robot 100a is internally or externally connected to the self-driving function of the self-driving vehicle 100b, or may perform operations in association with the driver of the self-driving vehicle 100b.

Herein, the robot 100a operating in conjunction with the self-driving vehicle 100b may obtain sensor information in place of the self-driving vehicle 100b so as to provide the information to the self-driving vehicle 100b, or obtain sensor information and generate surrounding environment information or object information so as to provide the information to the self-driving vehicle 100b, and thus control or supplement the self-driving function of the self-driving vehicle 100b. Alternatively, the robot 100a operating in conjunction with the self-driving vehicle 100b may monitor a driver of the self-driving vehicle 100b, or control functions of the self-driving vehicle 100b by operating in conjunction with the driver. For example, when it is determined that the driver is drowsy, the robot 100a may activate the self-driving function of the self-driving vehicle 100b or control the driving part of the self-driving vehicle 100b. Herein, functions of the self-driving vehicle 100b which are controlled by the robot 100a include, in addition to the self-driving function, functions provided from a navigation system or audio system provided in the self-driving vehicle 100b.

Alternatively, the robot 100a operating in conjunction with the self-driving vehicle 100b may provide information or supplement functions of the self-driving vehicle 100b from the outside of the self-driving vehicle 100b. For example, the robot 100a may provide traffic information including signal information such as smart signals to the self-driving vehicle 100b, or may automatically connect to an electrical charging device such as an automatic electric charger of an electric vehicle by operating in conjunction with the self-driving vehicle 100b.

The robot 100a may be employed in a guide robot, a transport robot, a cleaning robot, a wearable robot, an entertainment robot, a pet robot, an unmanned flying robot, a drone, etc. by applying the AI technique and the XR technique thereto. The robot 100a to which the XR technique is applied may mean a robot that becomes a target controlled/operated within an XR image. Herein, the robot 100a may be distinguished from the XR device 100c and operate in conjunction with the same.

For the robot 100a that becomes a target controlled/operated within an XR image, when sensor information is obtained from sensors including a camera, the robot 100a or the XR device 100c may generate an XR image on the basis of the sensor information, and the XR device 100c may output the generated XR image. In addition, the above robot 100a may operate on the basis of a control signal input through the XR device 100c, or in conjunction with the user. For example, the user may check an XR image in association with a view of the robot 100a that is in conjunction with the external device such as XR device 100c in a remote manner, adjust a self-driving path of the robot 100a through in conjunction with the robot 100a, control operations or driving, or check information on surrounding objects.

The self-driving vehicle 100b may be employed in a movable robot, a vehicle, an unmanned flying robot, etc. by applying the AI technique and the XR technique thereto. The self-driving vehicle 100b to which the XR technique is applied may mean self-driving vehicle provided with a device providing an XR image, and self-driving vehicle that becomes a target controlled/operated within an XR image, etc. Particularly, the self-driving vehicle 100b that becomes a target controlled/operated within an XR image may be distinguished from the XR device 100c, and operate in conjunction with the same.

The self-driving vehicle 100b provided with a device providing an XR image may obtain sensor information from sensors including a camera, and output an XR image generated on the basis of the obtained sensor information. For example, the self-driving vehicle 100b outputs an XR image by using a HUD, and thus provides to a passenger a real object or XR object in association with objects within a screen.

Herein, when the XR object is displayed on the HUD, at least a part of the XR object may be displayed to overlap the real object to which the passenger's eyes are directed. On the other hands, when the XR object displayed on a display included in the self-driving vehicle 100b, at least a part of the XR object may be displayed to overlap an object within the screen. For example, the self-driving vehicle 100b may output XR objects in association with carriageways, other vehicles, signals, traffic signs, motorcycles, pedestrians, buildings, etc.

For the self-driving vehicle 100b that becomes a target controlled/operated within an XR image, when sensor information is obtained from sensors including a camera, the self-driving vehicle 100b or XR device 100c may generate an XR image on the basis of the sensor information, and the XR device 100c may output the generated XR image. In addition, the above self-driving vehicle 100b may operate on the basis of a control signal input through the external device such as XR device 100c, etc. or in conjunction with the user.

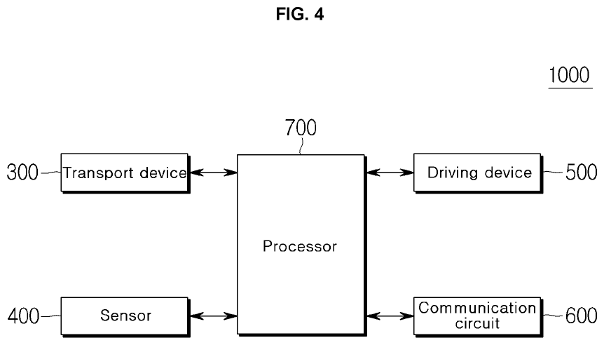

FIG. 4 is a view showing a robot according to embodiments of the present disclosure. Referring to FIG. 4, a robot 1000 may include a transport device 300, a sensor 400, a driving device 500, a communication circuit 600, and a processor 700.

The robot 1000 shown in FIG. 4 may store a package, may autonomously drive to a destination, and may automatically off-load (or unload) the stored package, when arriving at the destination. For example, the robot 1000 may be a delivery robot.

The transport device 300 may be a device that stores a package to be delivered and automatically loads and unloads the package. The transport device 300 and the robot may be collectively referred to as various terms, for example, an off-loading device, an unloading device, a delivery device, a transfer device, or the like. When necessary, the transport device 300 may be utilized by being combined to a vehicle, a movable robot, or the like. According to embodiments, the transport device 300 may efficiently off-load the transport objects stacked in multiple layers, starting from the transport object on the lower layer to the transport object on the upper layer sequentially. The structure and the function of the transport device 300 will be described later.

The sensor 400 may detect the surrounding environment of the robot 1000 and may generate information on the detected surrounding environment. According to embodiments, the sensor 400 may include a camera, a lidar, a radar, an ultrasonic sensor, a proximity sensor, an optical sensor, or the like, but it is not limited thereto. The sensor 400 may generate detection data corresponding to a result of detection. According to embodiments, the communication circuit 600 may perform the function of the communication circuit 110 shown in FIG. 1.

The driving device 500 may generate driving force to move the robot 1000. According to embodiments, the driving device 500 may be a motor, an actuator, or a steering device, but it is not limited thereto. The driving device 500 may generate driving force for walking or driving of the robot 1000. For example, the robot 1000 may include a traveling device or a walking device, such as a wheel, a belt, a leg, or the like, and may move by transferring the driving force generated by the driving device 500 to the traveling device or the walking device. According to embodiments, the driving device 500 may generate the driving force for the robot 1000 to autonomously drive from the source to the destination, according to control by the processor 700, and may control driving of the robot 1000 during autonomous driving of the robot 1000.

The communication circuit 600 may be configured to transmit and receive wireless signals. According to embodiments, the communication circuit 600 may be a transceiver configured to transmit and receive wireless signals. According to embodiments, the communication circuit 600 may perform the function of the communication circuit 110 shown in FIG. 1. For example, the communication circuit 600 may perform communication with another robot or a server.

The processor 700 may be configured to control the overall operations of the robot 1000. According to embodiments, the processor 700 may include a processor having a calculation processing function. For example, the processor 700 may include a calculation processing device such as a central processing unit (CPU), a micro controller unit (MCU), an application specific integrated circuit (ASIC), a field programmable gate array (FPGA), a graphics processing unit (GPU), or the like, but it is not limited thereto.

The processor 700 may control the transport device 300. According to embodiments, the processor 700 may transmit an off-load command for off-loading the package, to the transport device 300. When the off-load command is transmitted, the transport device 300 performs an off-load operation for off-loading the stored (or stacked) package.

The processor 700 may control the driving device 500 by using sensor data generated by the sensor 400. According to embodiments, the processor 700 may generate a command for controlling the driving device 500, by using the sensor data. The processor 700 may generate an operation command corresponding to a wireless signal received through the communication circuit 600, and may control the robot 1000 by using the generated operation command.

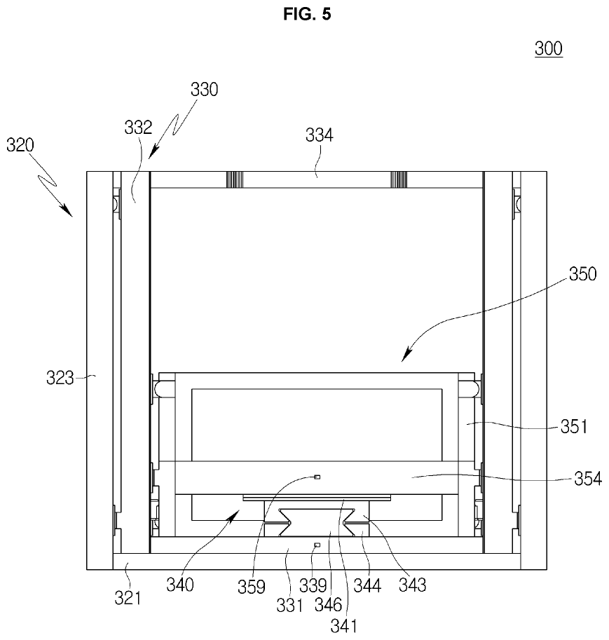

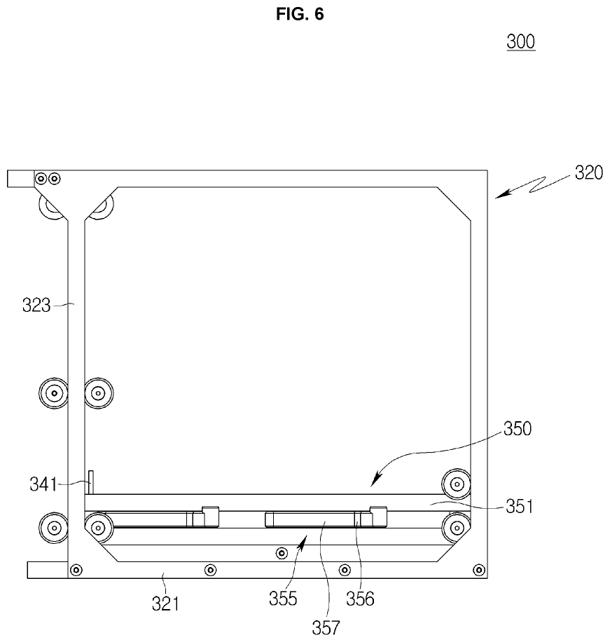

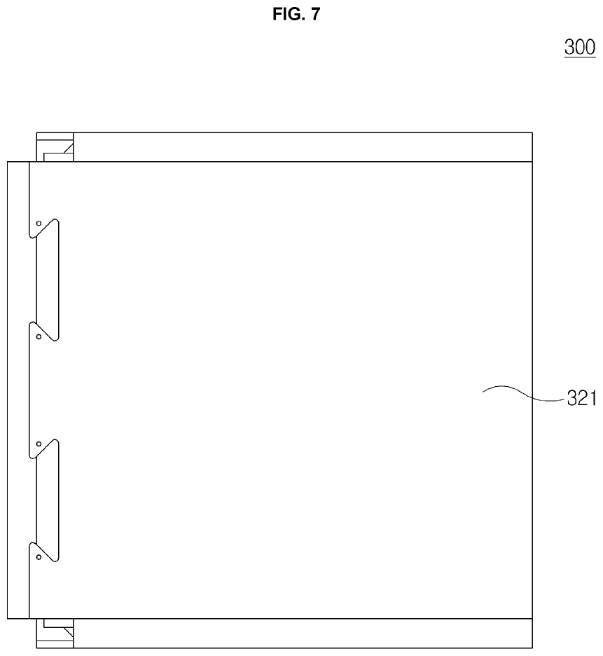

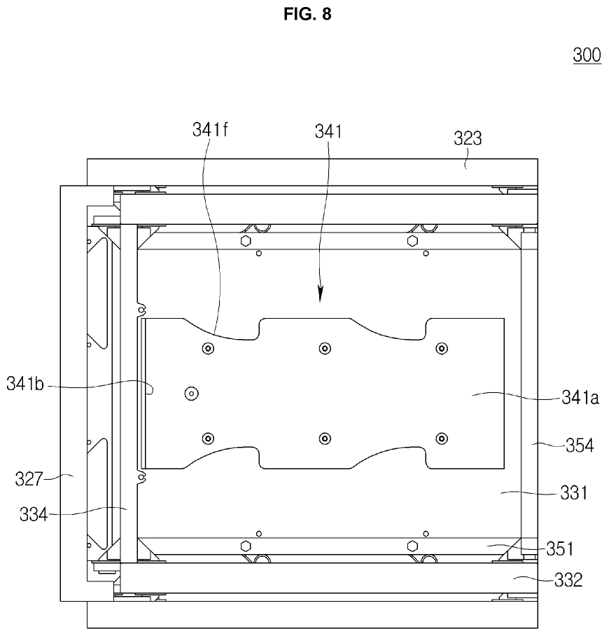

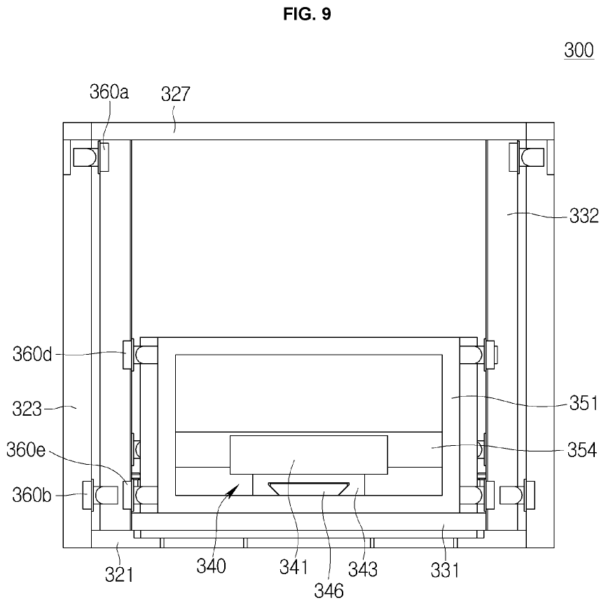

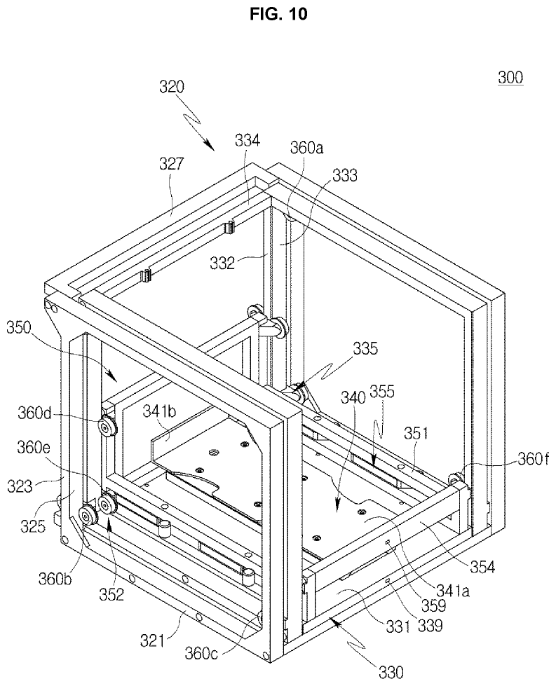

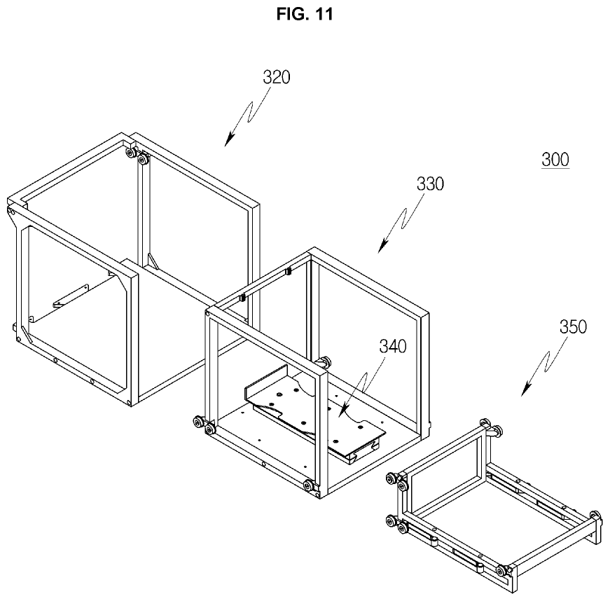

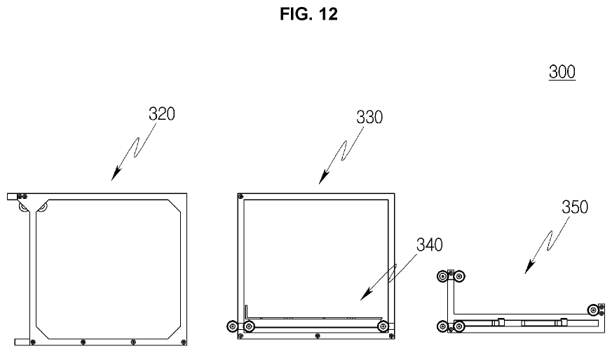

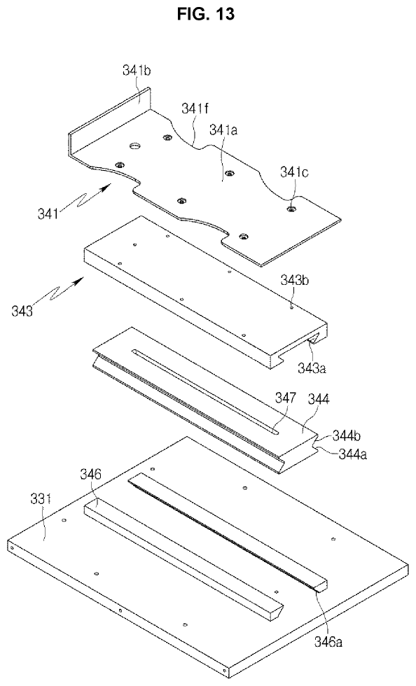

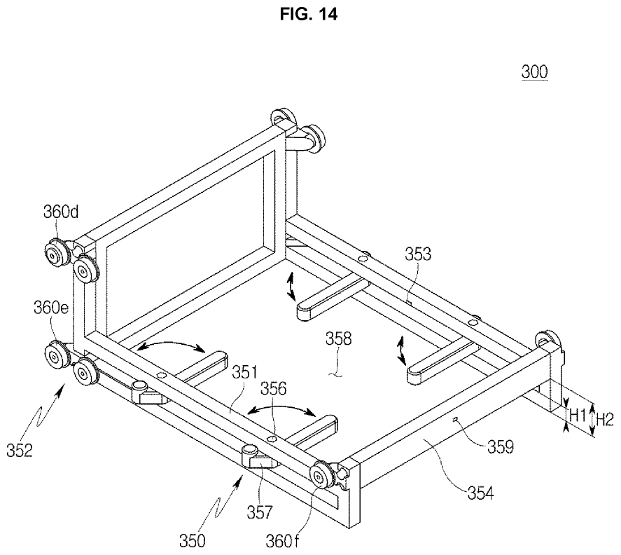

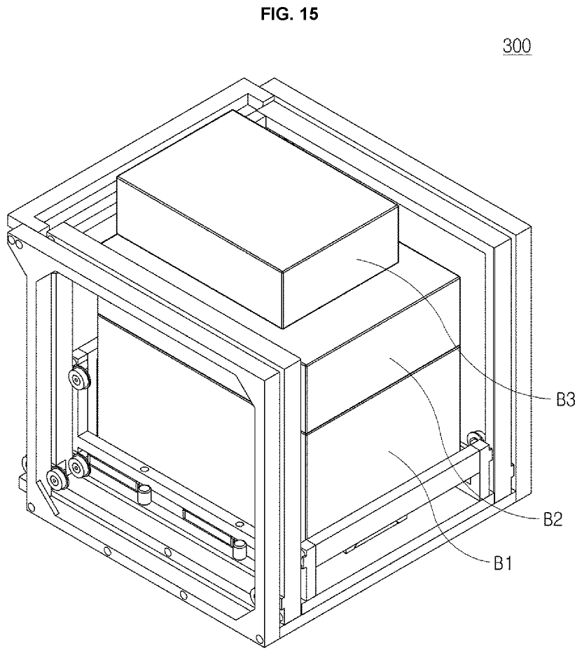

FIG. 5 is a front view showing the transport device 300 according to embodiments of the present disclosure; FIG. 6 is a side view showing the transport device 300 according to embodiments of the present disclosure; FIG. 7 is a bottom view showing the transport device 300 according to embodiments of the present disclosure; FIG. 8 is a plan view showing the transport device 300 according to embodiments of the present disclosure; FIG. 9 is a back view showing the transport device 300 according to embodiments of the present disclosure; FIG. 10 is a perspective view showing the transport device 300 according to embodiments of the present disclosure; FIG. 11 is an exploded perspective view showing the transport device 300 according to embodiments of the present disclosure; FIG. 12 is an exploded side view showing the transport device 300 according to embodiments of the present disclosure; FIG. 13 is an exploded perspective view showing a pusher unit 340 according to embodiments of the present disclosure; FIG. 14 is a perspective view showing a second stage unit 350 according to embodiments of the present disclosure; and FIG. 15 is a view showing a state in whch multiple transport objects are stacked in the transport device 300 according to embodiments of the present disclosure. A linear guide structure mentioned below may be a known structure, and thus a detailed description thereof will be omitted.

Referring to FIGS. 5 to 15, the transport device 300 according to embodiments of the present disclosure may include a device frame 320, a first stage unit (or first stage) 330, a pusher unit (or pusher) 340, and a second stage unit (or second stage) 350. Firstly, the device frame 320 may include a base plate 321, one or more base beams 323, and a first rail 325. The base plate 321 may be implemented in a shape of a quadrangular plate in the present disclosure, but the shape is not limited thereto. The multiple base beams 323 may be placed at the base plate 321 in the vertical direction. A connection beam 327 connecting the multiple base beams 323 is placed on the upper portions of the base beams 323 so that the overall shape of the device frame 320 is maintained. Further, the first rail 325 may be placed in the vertical direction along the base beam 323. The first rail 325 may serve as a guide rail on which a first lifting unit (or first lift) 335, which will be described later, moves in the vertical direction.

Secondly, the first stage unit 330 may be placed in the device frame 320 to be movable in the vertical direction. The first stage unit 330 may include a first frame 331, one or more first support beams 332, a first lifting unit 335, a first sensor 339, and a second rail 333.

The first frame 331 may be placed on the top of the base plate 321, and may be implemented in a shape of a quadrangular plate. However, the shape is not limited thereto. The multiple first support beams 332 may be placed at the first frame 331 in the vertical direction. A first connection beam 334 connecting the multiple first support beams 332 is placed on the upper portions of the first support beams 332 so that the overall shape of the first stage unit 330 is maintained. The second rail 333 may be placed in the vertical direction along the first support beam 332. The second rail 333 may serve as a guide rail on which a second lifting unit (or second lift) 352, which will be described later, moves in the vertical direction.

The first lifting unit 335 may be placed at the first support beam 332 and may be provided to be movable in the vertical direction along the first rail 325. The first lifting unit 335 may be the linear guide structure being in conjunction with the first rail 325 in the present disclosure, but without being limited thereto, other lifting devices may be adopted. Herein, in order to facilitate movement when the first lifting unit 335 moves in the vertical direction along the first rail 325, an upper portion of the base beam 323 and lower portions of the first support beams 332 may be provided with respective wheel members 360a, 360b, and 360c.

The first sensor 339 may be placed at the first frame 331, and may be provided to measure a top boundary surface of the discharged transport object. The processor 700 may control, by using the sensor data generated by the first sensor 339, the first lifting unit 335 so as to change the vertical position of the pusher unit 340 to the position that corresponds to or is above the top surface of the discharged transport object. Herein, the first lifting unit 335 may move in the vertical direction and may change the vertical position of the pusher unit 340. Further, the second rail 333 may be placed in the vertical direction at the first support beam 332. The second rail 333 may serve as a guide rail on which a second lifting unit 352, which will be described later, moves in the vertical direction.

Thirdly, the pusher unit 340 may be placed in the first stage unit 330, and may be provided to discharge or off-load/unload the transport object outward. Referring to FIG. 13, the pusher unit 340 may include a first guide block 346, a second guide block 344, a moving block 343, and a pusher block 341.

The first guide block 346 may be implemented as one pair of beams, wherein the beams may be placed on the top of the first frame 331 and spaced apart from each other by a predetermined distance. The second guide block 344 may be placed on the top of the first frame 331, and may be engaged with the first guide block 346. The first guide block 344 and the second guide block 346 may be the linear guide structures, and may be implemented in a structure in which the second guide block 344 moves along the first guide block 346 while the first guide block 346 is fixed on the first frame 331. However, without being limited thereto, other driving devices capable of reciprocating driving may be adopted.

The first guide block 346 is provided with a first curved surface 346a in the longitudinal direction, and the second guide block 344 is provided with a second curved surface 344a opposite to the first curved surface 346a, so that the second guide block 344 is placed in a manner that is inserted in the longitudinal direction of the first guide block 346. Further, into the top surface of the second guide block 344, a moving groove 347 is provided in the longitudinal direction.

The moving block 343 may be placed on the top of the second guide block 344, and may be provided to move in the longitudinal direction of the second guide block 344. A connection part (not shown) may be placed at the bottom of the moving block 343, and the connection part may be inserted into the moving groove 347 and thus connected to the linear guide structure, whereby the moving block 343 moves along the moving groove 347.

Herein, the second guide block 344 is provided with a third curved surface 344b, and the moving block 343 is provided with a fourth curved surface 343a. Thus, the moving block 343 may move in the longitudinal direction of the second guide block 344 while being engaged with the second guide block 344.

The pusher block 341 may be connected to the top of the moving block 343, and may push the transport object to discharge the same. The moving block 343 and the pusher block 341 are provided with bolt holes 343b and 341c, respectively, and may thus be interconnected by being bolted.

The pusher block 341 may include a mounting plate 341a, a pusher plate 341b, and one or more cut-out portions 341f. The mounting plate 341a may be an element on which the transport object is mounted, and the pusher plate 341b may be an element pushing the transport object mounted on the mounting plate 341a outward to discharge the transport object.

Opposite sides of the pusher block 341 may be provided with cut-out portions 341f. These may be portions to which support bars 357, which will be described later, are inserted when the support bars 357 rotate. The number of the cut-out portions 341f may correspond to the number of support bars 357.

In order to mount the transport object on the mounting plate 341a of the pusher block 341, the second stage unit 350 descends to the upper portion of the pusher block 341. Herein, by securing the rotation spaces of the support bars 357, which support the bottom surface of the transport object, through the cut-out portions 341f, after the support bars 357 return to the original positions, the transport object is stably loaded on the mounting plate 341a of the pusher block 341 rather than falling thereon.

Fourthly, the second stage unit 350 may be placed in the first stage unit 330 to be movable in the vertical direction. In the case where the transport objects are stacked in multiple layers, the second stage unit 350 may perform a function of supporting the transport object on the upper layer while the pusher unit 340 discharges the transport object on the lower layer. Further, after the pusher unit 340 discharges the transport object on the lower layer, the second stage unit 350 may perform a function of mounting the transport object on the upper layer onto the pusher unit 340.

Referring to FIG. 14, the second stage unit 350 performing these functions may include a second frame 351, the second lifting unit 352, a second sensor 353, a stopper beam 354, one or more support units 355, and a third sensor 359. The second frame 351 may be provided with the center opened as an opening 358. Through the opening 358, the transport object on the upper layer may gently fall to the pusher block 341 and be mounted thereon.

The second lifting unit 352 may be placed at the second frame 351, and may be provided to be movable in the vertical direction along the second rail 333. The second lifting unit 352 may be the linear guide being in conjunction with the second rail 333 in the present disclosure, but without being limited thereto, other lifting devices may be adopted. Herein, in order to facilitate movement when the second lifting unit 352 moves in the vertical direction along the second rail 333, wheel members 360d, 360e, and 360f may be placed at multiple positions in the second stage unit 350, respectively.

The support units 355 may be placed at the second frame 351, and may be provided to support the transport object. The support unit 355 may include a rotation driving part 356, and the support bar 357. The rotation driving part 356 may be embedded in the second frame 351 and may be a motor in the present disclosure. However, without being limited thereto, other driving devices capable of rotational driving may be included.

The support bar 357 may be connected to a rotation shaft of the rotation driving part 356, and may rotate in the direction of the opening 358 to support the bottom of the transport object. That is, when the transport object on the lower layer is discharged outward by the pusher unit 340, the support bars 357 support the bottom of the transport object on the upper layer to prevent the transport object from falling.

The second sensor 353 may be placed at the second frame 351, and may be provided to measure boundary surfaces of the transport objects stacked in multiple layers. The processor 700 may control, by using the sensor data generated by the second sensor 353, the second lifting unit 352 so as to change the vertical position of the support bars 357 to the position that corresponds to the boundary surfaces of transport objects stacked in multiple layers. Herein, the second lifting unit 352 may move in the vertical direction and may change the vertical position of the support bars 357. This is to set the vertical position of the support bars 357 in advance so that when the transport object on the lower layer is discharged by the pusher unit 340, the support bars 357 are operated to support the bottom of the transport object on the upper layer.

Further, the stopper beam 354 performs a function in which when the pusher unit 340 moves the transport object outward and returns to the original position, a surface of the transport object is in contact with the stopper beam 354 so that the transport object does not return with the pusher unit 340 and is discharged from the mounting plate 341a outward. Referring to FIG. 14, the stopper beam 354 may be placed at the second frame 351 at a height H2 that is higher than a height H1 between the bottom surface of the second frame 351 and the bottom surface of the support bar 357. Accordingly, discharging of the transport object on the lower layer by the pusher unit 340 is not disturbed.

Further, the third sensor 359 may be placed at the stopper beam 354. The third sensor 359 may measure the top surface of the transport object mounted on the pusher unit 340. The processor 700 may control, by using the sensor data generated by the third sensor 359, the second lifting unit 352 so as to change the vertical position of the stopper beam 354 to the position that corresponds to or is below the top surface of the transport object mounted on the pusher unit 340. Herein, the second lifting unit 352 may move in the vertical direction and may change the vertical position of the stopper beam 354. This is to set the vertical position of the stopper beam 354 so that when the pusher unit 340 returns, the transport object is prevented from returning together and is discharged outward.

The configuration of the present disclosure has been described above, and the operation manner of the present disclosure by the configuration will be described below. FIG. 15 shows a state in which the transport objects (for example, courier boxes, and the like) are stacked in multiple layers in the transport device 300 according to embodiments of the present disclosure. Although not shown in the drawings, the transport device 300 according to embodiments of the present disclosure may be operated in combination with a separate vehicle, a separate movable robot, or the like. Hereinafter, for convenience of description, although the description is based on the transport objects stacked in three tiers, the technical idea may be applied to the transport objects stacked in other tiers within the same/similar range.

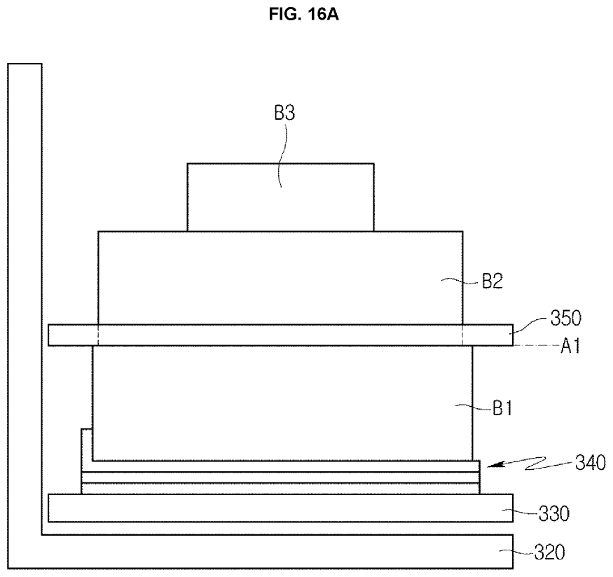

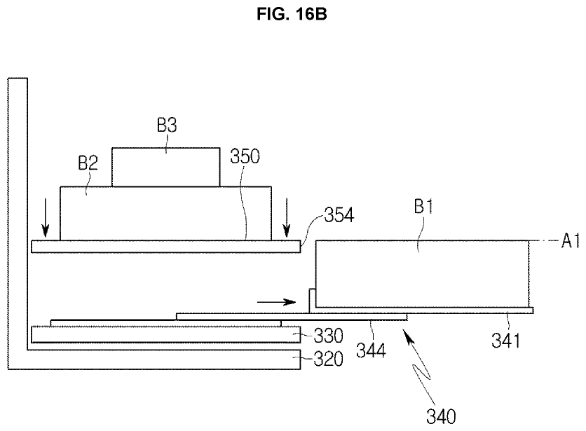

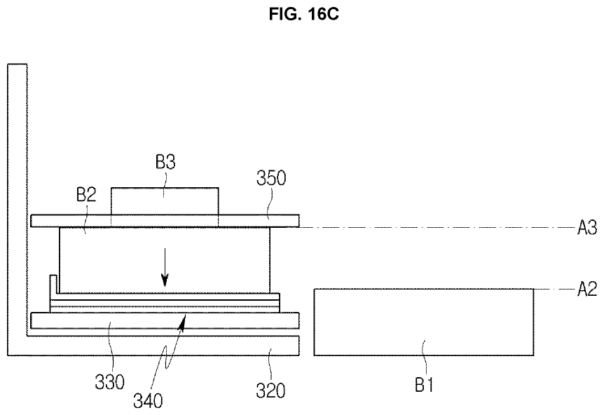

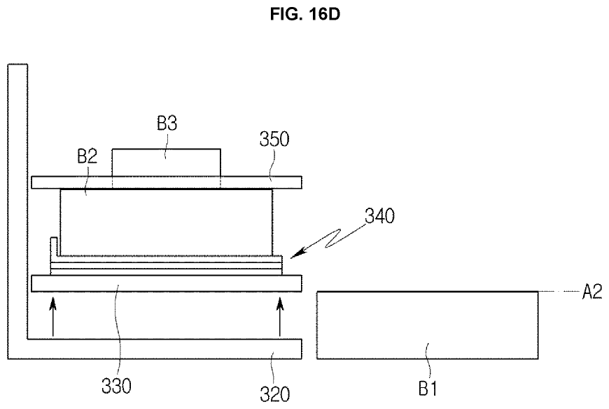

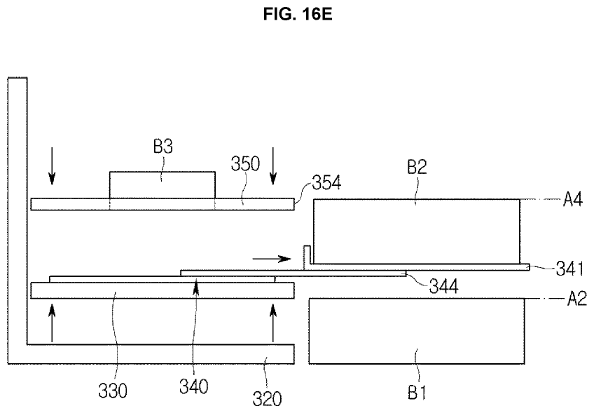

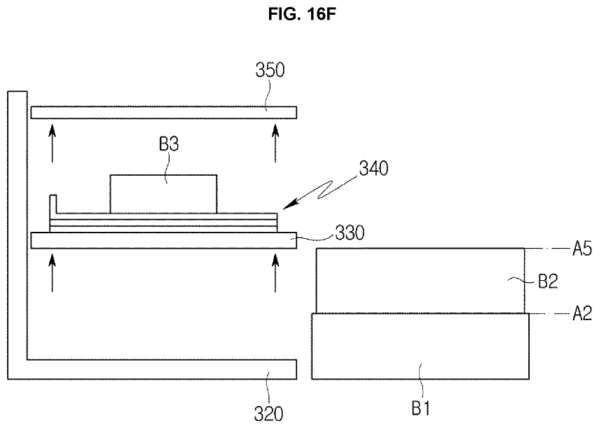

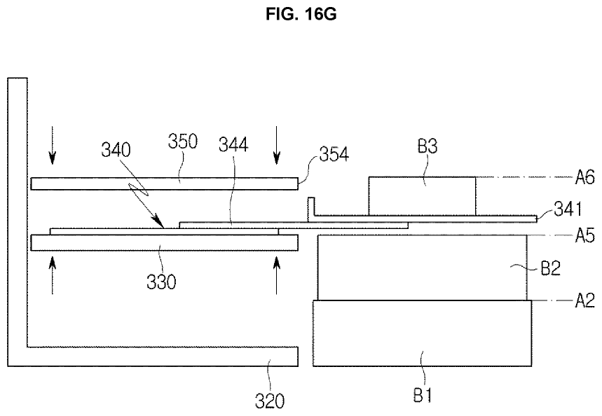

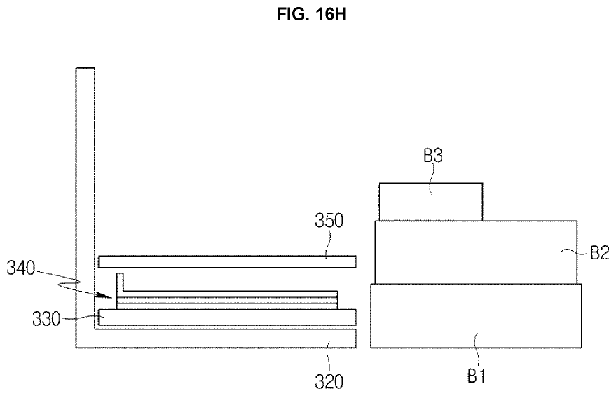

FIGS. 16A to 16H show an operation state in which the transport device 300 according to embodiments of the present disclosure off-loads multiple transport objects. In FIGS. 16A to 16H, the overall reference numerals are omitted to describe the operation manner, and the structure of each element is simply shown. Therefore, for the reference numerals of the detailed elements in the following description, refer to FIGS. 4 to 14.

First, FIG. 16A is a view simply showing a state in which the transport objects are stacked in multiple layers in the transport device 300 of the present disclosure shown in FIG. 15.

When the transport device 300 of the present disclosure arrives a destination by a separate means of transport, such as a vehicle, a movable robot, or the like, or by a means of transport equipped with the transport device 300, discharging, in other words, off-loading/unloading of the transport objects is prepared.

The transport objects B1, B2, B3 stacked in multiple layers are mounted on the pusher unit 340 placed in the first stage unit 330, before being discharged. Specifically, the transport objects B1, B2, B3 are mounted on the mounting plate 341a of the pusher block 341.

In order to discharge the transport object B1 at the first tier first, the second stage unit 350 is moved upward by the second lifting unit 352. Herein, when the second sensor 353 detects a boundary surface AI between the transport object B1 at the first tier and the transport object B2 at the second tier, the second stage unit 350 is lifted until it is enough for the support units 355 to support the bottom surface of the transport object B2 at the second tier.

Next, referring to FIG. 16B, the pusher unit 340 is operated to push the transport object B1 at the first tier outward and discharge the transport object B1. Specifically, the second guide block 344 is moved along the first guide block 346 by a predetermined distance outward, and the moving block 343 coupled to the second guide block 344 using the moving groove 347, and the pusher block 341 are moved by a predetermined distance. The sum of these moving distances is the distance at which the transport object B1 at the first tier is positioned outside the device frame 320.

While the transport object B1 at the first tier is discharged, the support bars 357 rotate to support the bottom of the transport object B2 at the second tier. Then, the second stage unit 350 is moved downward by the second lifting unit 352. Herein, the downward moving distance is a distance that corresponds to or is positioned below a top surface AI of the transport object B1 at the first tier. This may be detected by the third sensor 359.

Afterward, when the second guide block 344, the moving block 343, and the pusher block 341 return to the original positions, the transport object B1 at the first tier is blocked from returning by the stopper beam 354 of the second stage unit 350 and thus falls to the ground. In such an operation manner, the transport object B1 at the first tier is off-loaded at the destination.

Next, referring to FIG. 16C, after the transport object B1 at the first tier is discharged, the support bars 357 return to the original positions so that the transport object B2 at the second tier is mounted on the mounting plate 341a of the pusher block 341. Herein, in order to prevent the transport object B2 at the second tier from free falling from a high height, the second stage unit 350 descends to the top of the first frame 331 and the support bars 357 return to the original positions, whereby the transport object B2 at the second tier is safely mounted on the mounting plate 341a of the pusher block 341.

As described above, since the pusher block 341 is provided with the cut-out portions 341f, the rotation spaces of the support bars 357 are secured. Approaching to the mounting plate 341a of the pusher block 341, the support bars 357 are rotated, so that the transport object B2 at the second tier does not free fall or falls at a relatively low height, whereby the transport object B2 is safely mounted on the mounting plate 341a of the pusher block 341. The second sensor 353 may detect a boundary surface A3 between the transport object B2 at the second tier and the transport object B3 at the third tier, and the second stage unit 350 is moved to the position where the support units 355 are capable of supporting the transport object B3 at the third tier.

Next, referring to FIG. 16D, in order to discharge the transport object B2 at the second tier outward, the first stage unit 330 is moved upward by the first lifting unit 335. Herein, the first sensor 339 detects a top surface A2 of the discharged transport object B1, and the first lifting unit 335 moves the position of the pusher unit 340 to the position that corresponds to or is above the top surface A2 of the discharged transport object B1. According to embodiments, the first lifting unit 335 may adjust the vertical position of the pusher unit 340 so that the bottom surface of the transport object B2 at the second tier is positioned higher than the top surface A2 of the discharged transport object B1.

Next, referring to FIG. 16E, the pusher unit 340 is operated to push the transport object B2 at the second tier outward and discharge the transport object B2. Specifically, the second guide block 344 is moved along the first guide block 346 by a predetermined distance outward, and the moving block 343 coupled to the second guide block 344 using the moving groove 347, and the pusher block 341 are moved by a predetermined distance. The sum of these moving distances is the distance at which the transport object B2 at the second tier is positioned outside the device frame 320.

While the transport object B2 at the second tier is discharged, the support bars 357 rotate to support the transport object B3 at the third tier. This may be detected by the third sensor 359. Then, the second stage unit 350 is moved downward by the second lifting unit 352. Herein, the downward moving distance is a distance that corresponds to or is positioned below a top surface A4 of the transport object B2 at the second tier.

Afterward, when the second guide block 344, the moving block 343, and the pusher block 341 return to the original positions, the transport object B2 at the second tier is blocked from returning by the stopper beam 354 of the second stage unit 350 and thus falls to the top of the transport object B1 at the first tier. In such an operation manner, the transport object B2 at the second tier is off-loaded at the destination.

Next, referring to FIG. 16F, after the transport object B2 at the second tier is discharged, the support bars 357 return to the original positions so that the transport object B3 at the third tier is mounted on the mounting plate 341a of the pusher block 341. Herein, in order to prevent the transport object B3 at the third tier from free falling, the second stage unit 350 descends to the top of the first frame 331 and the support bars 357 return to the original positions, whereby the transport object B3 at the third tier is safely mounted on the mounting plate 341a of the pusher block 341.

Now, in order to discharge the transport object B3 at the third tier outward, the first sensor 339 detects a top surface A5 of the discharged transport object B2 at the second tier, and the first lifting unit 335 moves the first stage unit 330 to the position that corresponds to or is above the top surface A5 of the transport object B2 at the second tier. Accordingly, the pusher unit 340 is moved to the position that corresponds to or is above the top surface A5 of the transport object B2 at the second tier. Herein, the second stage unit 350 has no transport object to support, so the second stage unit 350 is moved upward not to disturb discharging.

Next, referring to FIG. 16G, the pusher unit 340 is operated to push the transport object B3 at the third tier outward and discharge the transport object B3. Specifically, the second guide block 344 is moved along the first guide block 346 by a predetermined distance outward, and the moving block 343 coupled to the second guide block 344 using the moving groove 347, and the pusher block 341 are moved by a predetermined distance. The sum of these moving distances is the distance at which the transport object B3 at the third tier is positioned outside the device frame 320.

Then, the second stage unit 350 is moved downward by the second lifting unit 352. Herein, the downward moving distance is a distance that corresponds to or is positioned below a top surface A6 of the transport object B3 at the third tier. This may be detected by the third sensor 359.

Afterward, when the second guide block 344, the moving block 343, and the pusher block 341 return to the original positions, the transport object B3 at the third tier is blocked from returning by the stopper beam 354 of the second stage unit 350 and thus falls to the top of the transport object B2 at the second tier. In such an operation manner, as shown in FIG. 16H, finally, the transport object B3 at the third tier is off-loaded at the destination, finishing the transport.

According to the present disclosure, through the above configuration and operation manner, the transport objects stacked in multiple layers can be efficiently off-loaded, starting from the transport object on the lower layer to the transport object on the upper layer sequentially.

The transport device 300 according to embodiments of the present disclosure may be operated according to control by the robot 100 or the server 200. According to embodiments, the transport device 300 may off-load the transport objects according to the control signal transmitted from the processor 180 of the robot, or may off-load the transport objects according to the control signal transmitted from the processor 260 of the server 200.

According to embodiments, in the case where the transport device 300 is operated according to the control by the robot 100, the transport device 300 may be integrated in the robot 100. For example, the robot 100 may drive, including a driving unit having a driving function, and may off-load the transport objects by controlling the transport device 300. That is, when the transport objects are loaded, the robot 100 including the transport device 300 autonomously drives to the destination (off-load location). When arriving at the destination, the robot 100 controls the transport device 300 to off-load the transport objects loaded in the transport device 300.

The control method of the robot or operation method of the processor according to embodiments of the present disclosure may be stored in a computer readable storage medium so as to be employed in commands executable by the processor. The storage medium can include a database, including distributed database, such as a relational database, a non-relational database, an in-memory database, or other suitable databases, which can store data and allow access to such data via a storage controller, whether directly and/or indirectly, whether in a raw state, a formatted state, an organized stated, or any other accessible state. In addition, the storage medium can include any type of storage, such as a primary storage, a secondary storage, a tertiary storage, an off-line storage, a volatile storage, a non-volatile storage, a semiconductor storage, a magnetic storage, an optical storage, a flash storage, a hard disk drive storage, a floppy disk drive, a magnetic tape, or other suitable data storage medium.

Accordingly, the present disclosure has been made keeping in mind the above problems occurring in the related art, and the present disclosure is intended to provide a transport device and a robot including the same, the transport device being capable of automatically off-loading transport objects stacked in multiple layers, starting from the transport object on the lower layer to the transport object on the upper layer sequentially.

According to embodiments of the present disclosure, there is provided a transport device unloading a transport object, the transport device including: a device frame; a first stage unit placed in the device frame to be movable in a vertical direction; a second stage unit placed in the first stage unit to be movable in a vertical direction; and a pusher unit placed in the first stage unit, and provided to discharge the transport object outward, wherein the transport object includes a first transport object and a second transport object stacked on the first transport object, and wherein while the pusher unit discharges the first transport object, the second stage unit supports the second transport object, and after the pusher unit discharges the first transport object, the second stage unit causes the second transport object to be mounted on the pusher unit.

According to embodiments of the present disclosure, there is provided a robot including: a transport device configured to unload a first transport object and a second transport object stacked on the first transport object; a driving device configured to generate driving force for moving the robot; and a processor, wherein the processor controls the transport device to unload the first and the second transport object, and wherein the transport device includes: a device frame; a first stage unit placed in the device frame to be movable in a vertical direction; a second stage unit placed in the first stage unit to be movable in a vertical direction; and a pusher unit placed in the first stage unit, and configured to unload the first and the second transport object sequentially.

According to the present disclosure, the transport objects stacked in multiple layers can be efficiently off-loaded, starting from the transport object on the lower layer to the transport object on the upper layer sequentially. In certain implementations, a transport device to unload at least one transport object, the transport device comprises: a device frame; a first stage configured to be positioned in the device frame and to be vertically movable; a second stage configured to be positioned in the first stage and to be vertically movable; and a pusher configured to be positioned in the first stage and to discharge the at least one transport object outward, wherein the at least one transport object includes a first transport object and a second transport object that is stacked on the first transport object, and wherein the second stage includes at least one support bar that moves, while the pusher discharges the first transport object, to a first position to support the second transport object, and after the pusher discharges the first transport object, to a second position that causes the second transport object to be mounted on the pusher.

The device frame may include: a base plate; a base beam positioned at the base plate to extend substantially vertically; and a first rail provided on the base beam. The first stage may include: a first frame positioned on an upper surface of the base plate; a first support beam positioned at the first frame and to extend substantially vertically; and a first lift positioned at the first support beam, and configured to move vertically along the first rail.

The pusher may include: a first guide block positioned on the first frame; a second guide block positioned on the first frame, and positioned to be movable in a longitudinal direction of the first guide block; a moving block positioned on the second guide block, and provided to be movable in a longitudinal direction of the second guide block; and a pusher block connected to a upper surface the moving block, and configured to push the at least one transport object to discharge the at least one transport object.

The first stage further may include: a second rail positioned at the first support beam to extend substantially vertically. The second stage may include: a second frame provided with an opening at a center thereof; and a second lift positioned at the second frame, and configured to be vertically movable along the second rail, wherein the support bar is positioned at the second frame. The second stage may include: a rotation motor positioned at the second frame, wherein the support bar is connected to a shaft of the rotation motor and is provided to rotate in a direction of the opening so as to support a bottom of the transport object.

The first stage may further include: a first sensor positioned at the first frame, and configured to determine a top surface of the discharged transport object, wherein the first lift moves vertically to move the pusher to a position that corresponds to or is above the top surface of the discharged transport object.

The at least one transport object may include transport objects that are stacked in multiple layers, and the second stage may further include: a second sensor positioned at the second frame, and configured to determine a boundary surface between the transport objects stacked in the multiple layers, wherein the second lift moves vertically to change a vertical position of the support bar to correspond to the boundary surface between the transport objects stacked in the multiple layers.

While the pusher discharges one of the transport objects positioned on a lower layer of the multiple layers, the support bar may rotate in a direction of the opening so as to support another one of the transport objects positioned on an upper layer of the multiple layers.

The second stage may further include: a stopper beam positioned at the second frame, wherein when the pusher returns, the stopper beam is positioned to contact a surface of the transport object and to block the transport object from returning, so that the transport object is separated from the pusher and is discharged outward. The second stage may further include: a third sensor positioned at the stopper beam, and configured to determine a top surface of the transport object when mounted on the pusher, wherein when the pusher is operated and the transport object is moved out of the device frame, the second lift moves vertically to move the stopper beam to a position that corresponds to or is below the top surface of the transport object moved out of the device frame.

The second stage may include a plurality of the support bars, and the pusher block may include: a mounting plate connected to the moving block and on which the transport object is mounted; a pusher plate connected to a side portion of the mounting plate, and provided to push the transport object and discharge the transport object outward; and cut-out portions provided at opposite sides of the mounting plate to receive the plurality of support bars when the the plurality of support bars move to support the transport object.

In certain implementations, a robot may comprise: a transport device configured to unload a first transport object and a second transport object that is stacked on the first transport object; a motor configured to move the robot; and a processor that controls the transport device to unload the first transport object and the second transport object, wherein the transport device includes: a device frame; a first stage positioned in the device frame and configured to be vertically movable; a second stage positioned in the first stage and configured to be vertically movable; and a pusher positioned in the first stage and configured to unload the first and the second transport object sequentially.

While the pusher unloads the first transport object, the second stage supports the second transport object, and after the pusher unloads the first transport object, the second stage releases the second transport object to be mounted on the pusher.

The robot may further comprise: a first sensor configured to detect a top surface of the unloaded first transport object, wherein the processor changes, after the first transport object is unloaded, a vertical position of the pusher so that a bottom surface of the second transport object mounted on the pusher is positioned higher than the top surface of the unloaded first transport object.

The robot may further comprise: a second sensor configured to detect a boundary surface between the first transport object and the second transport object, wherein the processor changes a vertical position of the second stage based on the boundary surface so that the second stage supports the second transport object while the pusher discharges the first transport object.

The robot may further comprise: a third sensor configured to detect a top surface of the first transport object when mounted on the pusher, wherein the processor changes a vertical position of the second stage based on the top surface of the first transport object mounted on the pusher so that the first transport object is unloaded as the pusher is operated and does not return with the pusher.

The pusher may include: a first guide block positioned on the first stage; a second guide block positioned on the first stage, and positioned to be movable in a longitudinal direction of the first guide block; a moving block positioned on the second guide block, and provided to be movable in a longitudinal direction of the second guide block; and a pusher block connected to an upper surface of the moving block, and configured to push and discharge the first transport object and the second transport object.

The processor may determine a moving path that includes a location to unload the first and the second transport object, and may control the motor so that the robot moves along the moving path.

Through conjunction with various sensing operations, robot operations, and the like, as the transport objects are automatically off-loaded, the user does not need to off-load the transport objects, so the user's work fatigue is reduced and a relatively heavy transport object is efficiently off-loaded without using a separate machine.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A transport device to unload at least one transport object, the transport device comprising:
a device frame;
a first stage configured to be positioned in the device frame and to be vertically movable;
a second stage configured to be positioned in the first stage and to be vertically movable; and
a pusher configured to be positioned in the first stage and to discharge the at least one transport object outward,
wherein the at least one transport object includes a first transport object and a second transport object that is stacked on the first transport object, and
wherein the second stage includes at least one support bar that moves, while the pusher discharges the first transport object, to a first position to support the second transport object, and after the pusher discharges the first transport object, to a second position that causes the second transport object to be mounted on the pusher.

2. The transport device of claim 1, wherein the device frame includes:
a base plate;
a base beam positioned at the base plate to extend substantially vertically; and
a first rail provided on the base beam.

3. The transport device of claim 2, wherein the first stage includes:
a first frame positioned on an upper surface of the base plate;
a first support beam positioned at the first frame and to extend substantially vertically; and
a first lift positioned at the first support beam, and configured to move vertically along the first rail.

4. The transport device of claim 3, wherein the pusher includes:
a first guide block positioned on the first frame;
a second guide block positioned on the first frame, and positioned to be movable in a longitudinal direction of the first guide block;
a moving block positioned on the second guide block, and provided to be movable in a longitudinal direction of the second guide block; and
a pusher block connected to a upper surface the moving block, and configured to push the at least one transport object to discharge the at least one transport object.

5. The transport device of claim 4, wherein the first stage further includes:
a second rail positioned at the first support beam to extend substantially vertically.

6. The transport device of claim 5, wherein the second stage includes:
a second frame provided with an opening at a center thereof; and
a second lift positioned at the second frame, and configured to be vertically movable along the second rail,
wherein the support bar is positioned at the second frame.

7. The transport device of claim 6, wherein the second stage includes:
a rotation motor positioned at the second frame,
wherein the support bar is connected to a shaft of the rotation motor and is provided to rotate in a direction of the opening so as to support a bottom of the transport object.

8. The transport device of claim 5, wherein the first stage further includes:
a first sensor positioned at the first frame, and configured to determine a top surface of the discharged transport object, and
wherein the first lift moves vertically to move the pusher to a position that corresponds to or is above the top surface of the discharged transport object.

9. The transport device of claim 7, wherein the at least one transport object includes transport objects that are stacked in multiple layers, and the second stage further includes:
a second sensor positioned at the second frame, and configured to determine a boundary surface between the transport objects stacked in the multiple layers, and
wherein the second lift moves vertically to change a vertical position of the support bar to correspond to the boundary surface between the transport objects stacked in the multiple layers.

10. The transport device of claim 9, wherein while the pusher discharges one of the transport objects positioned on a lower layer of the multiple layers, the support bar rotates in a direction of the opening so as to support another one of the transport objects positioned on an upper layer of the multiple layers.

11. The transport device of claim 7, wherein the second stage further includes:
a stopper beam positioned at the second frame, and
wherein when the pusher returns, the stopper beam is positioned to contact a surface of the transport object and to block the transport object from returning, so that the transport object is separated from the pusher and is discharged outward.

12. The transport device of claim 11, wherein the second stage further includes:
a third sensor positioned at the stopper beam, and configured to determine a top surface of the transport object when mounted on the pusher, and
wherein when the pusher is operated and the transport object is moved out of the device frame, the second lift moves vertically to move the stopper beam to a position that corresponds to or is below the top surface of the transport object moved out of the device frame.

13. The transport device of claim 7, wherein the second stage includes a plurality of the support bars, and the pusher block includes:
a mounting plate connected to the moving block and on which the transport object is mounted;
a pusher plate connected to a side portion of the mounting plate, and provided to push the transport object and discharge the transport object outward; and
cut-out portions provided at opposite sides of the mounting plate to receive the plurality of support bars when the plurality of support bars move to support the transport object.

14. A robot comprising:
a transport device configured to unload a first transport object and a second transport object that is stacked on the first transport object;
a motor configured to move the robot; and
a processor that controls the transport device to unload the first transport object and the second transport object,
wherein the transport device includes:
a device frame;
a first stage positioned in the device frame and configured to be vertically movable;
a second stage positioned in the first stage and configured to be vertically movable; and
a pusher positioned in the first stage and configured to unload the first and the second transport object sequentially.

15. The robot of claim 14, wherein while the pusher unloads the first transport object, the second stage supports the second transport object, and after the pusher unloads the first transport object, the second stage releases the second transport object to be mounted on the pusher.

16. The robot of claim 15, further comprising:
a first sensor configured to detect a top surface of the unloaded first transport object,
wherein the processor changes, after the first transport object is unloaded, a vertical position of the pusher so that a bottom surface of the second transport object mounted on the pusher is positioned higher than the top surface of the unloaded first transport object.

17. The robot of claim 15, further comprising:
a second sensor configured to detect a boundary surface between the first transport object and the second transport object,
wherein the processor changes a vertical position of the second stage based on the boundary surface so that the second stage supports the second transport object while the pusher discharges the first transport object.

18. The robot of claim 15, further comprising:
a third sensor configured to detect a top surface of the first transport object when mounted on the pusher,
wherein the processor changes a vertical position of the second stage based on the top surface of the first transport object mounted on the pusher so that the first transport object is unloaded as the pusher is operated and does not return with the pusher.

19. The robot of claim 14, wherein the pusher includes:
a first guide block positioned on the first stage;
a second guide block positioned on the first stage, and positioned to be movable in a longitudinal direction of the first guide block;
a moving block positioned on the second guide block, and provided to be movable in a longitudinal direction of the second guide block; and
a pusher block connected to an upper surface of the moving block, and configured to push and discharge the first transport object and the second transport object.

20. The robot of claim 14, wherein the processor determines a moving path that includes a location to unload the first and the second transport object, and controls the motor so that the robot moves along the moving path.
